(19) United States
(12) Patent Application Publication
(10) Pub. No.: US 2024/0193702 A1
(43) Pub. Date: Jun. 13, 2024

(54) SOCIAL MEDIA PLATFORM INCLUDING DEFINED BOUND SENTIMENT MODIFIERS FOR PLATFORM CONCEPTS AND SOCIAL MEDIA ARTIFICIAL INTELLIGENCE ALGORITHM SYSTEMS IMPLEMENTING THE SAME

(71) Applicant: Brian M. Sullivan, Wexford, PA (US)

(72) Inventor: Brian M. Sullivan, Wexford, PA (US)

(21) Appl. No.: 18/538,904

(22) Filed: Dec. 13, 2023

Related U.S. Application Data
(60) Provisional application No. 63/533,796, filed on Aug. 21, 2023.
(60) Provisional application No. 63/432,149, filed on Dec. 13, 2022.

(51) Int. Cl. G06Q 50/00

(52) U.S. Cl. CPC G06Q 50/01

(57) ABSTRACT

A social media platform accessed online by platform user devices forming a collection of interactive media technologies that facilitate the creation and sharing of user created content of information, ideas, interests, and other forms of expression through virtual communities and networks of the user devices. The platform provides a predefined set of sentiment identifiers which are bindable to user defined content components of the user created content; wherein the bound content-sentiment pairings are indexable, searchable and analyzable by the platform or users on the platform. Platform AI systems index search and analyze the bound content-sentiment pairings of user content.

### RELATED APPLICATIONS

The present application claims the benefit of U.S. Provisional Patent Application Ser. No. 63/533,796 filed Aug. 21, 2023 which application is incorporated herein by reference.

The present application claims the benefit of U.S. Provisional Patent Application Ser. No. 63/432,149 filed Dec. 13, 2022 which application is incorporated herein by reference.

### BACKGROUND INFORMATION

### 1. Field of the Invention

The present invention relates to social media platforms. More specifically, the present invention relates to social media platform content including defined graphical sentiment modifiers for platform concepts and social media artificial intelligence algorithm systems implementing the same. Social media is also understood to include messaging within workplaces and organizations, whether for-profit and non-profit. The present system can just as easily be used within a workplace and can be monitored to determine the overall emotional and cultural health of a workplace or organization.

### 2. Background of the Invention

Social media platforms, also called social media networks or simply social media, are interactive media technologies that facilitate the creation and sharing of information, ideas, interests, and other forms of expression through virtual communities and networks. See Kietzmann, Jan H.; Hermkens, Kristopher (2011). Social media? Get serious! Understanding the functional building blocks of social media. Business Horizons 54 (3): 241-251.; and Obar, Jonathan A.; Wildman, Steve (2015). Social media definition and the governance challenge: An introduction to the special issue. Telecommunications Policy. 39 (9): 745-750.

While challenges to the definition of social media arise due to the variety of stand-alone and built-in social media services on distinct platforms that are currently available, there are some common features:
1. Social media are interactive Internet-based applications.
2. User-generated content— such as text posts or comments, digital photos or videos, and data generated through all online interactions— is the lifeblood of social media.
3. Users create service-specific profiles for the website or app that are designed and maintained by the social media organization.
4. Social media helps the development of online social networks by connecting a user's profile with those of other individuals or groups.

The term social in regard to media suggests that platforms are user-centric and enable communal activity. As such, social media can be viewed as online facilitators or enhancers of human networks-webs of individuals who enhance social connectivity. See Dijck, Jose van (2013-01-02). The Culture of Connectivity: A Critical History of Social Media. Oxford University Press.

Users usually access social media services through web-based apps on desktops or download services that offer social media functionality to their mobile devices (e.g., smartphones and tablets). As users engage with these electronic services, they create highly interactive platforms which individuals, communities, and organizations can share, co-create, discuss, participate, and modify user-generated or self-curated content posted online. See Boyd, Danah M.; Ellison, Nicole B. (2007). Social Network Sites: Definition, History, and Scholarship. Journal of Computer-Mediated Communication. 13 (1): 210-30.

Additionally, social media are used to document memories, learn about and explore things, advertise oneself, and form friendships along with the growth of ideas from the creation of blogs, podcasts, videos, and gaming sites. This changing relationship between humans and technology is the focus of the emerging field of technological self-studies. Some of the most popular social media websites, with more than 100 million registered users, include FACEBOOK (and its associated FACEBOOK MESSENGER), TIKTOK, WECHAT, INSTAGRAM, QZONE, WEIBO, X (Formerly TWITTER), TUMBLR, BAIDU TIEBA, and LINKEDIN. Depending on interpretation, other popular platforms that are sometimes referred to as social media services include YOUTUBE, QQ, QUORA, TELEGRAM, WHATSAPP, SIGNAL, LINE, SNAPCHAT, PINTEREST, VIBER, REDDIT, DISCORD, VK, MICROSOFT TEAMS, and more. WIKIS is an example of collaborative content creation. Social media is also understood to include messaging within workplaces and organizations, whether for-profit and non-profit.

Social media platforms differ from traditional media (e.g., print magazines and newspapers, TV, and radio broadcasting) in many ways, including quality, reach, frequency, usability, relevancy, and permanence. Additionally, social media outlets operate in a dialogic transmission system (i.e., many sources broadcasting to many receivers) while traditional media outlets operate under a monologic transmission model (i.e., one source to many receivers). For instance, a newspaper is delivered to many subscribers, and a radio station broadcasts the same programs to an entire city. Since the dramatic expansion of the Internet, digital media or digital rhetoric can be used to represent or identify a culture. Studying the rhetoric that exists in the digital environment has become a crucial new process for many scholars.

There is a significant amount of content floating around in the social media platforms space. Literally, thousands of posts, photos and videos are published per minute. Without social media algorithms, sifting through all of this content on an account-by-account basis would be impossible. Especially for users following hundreds or thousands of accounts on a network, so algorithms do the legwork of delivering what users want and weeding out content that's deemed irrelevant or low-quality. In theory, that is.

Social networks prioritize which content a user sees in their feed first by the likelihood that they'll actually want to see it. Before the switch to algorithms, most social media feeds displayed posts in reverse chronological order. In short, the newest posts from accounts a user followed showed up first. By default, social media platform algorithms take the reins of determining which content to deliver to a platform user based on the user's behavior. For example, FACEBOOK or X (formerly TWITTER) might put posts from a user's closest friends and family front-and-center in the user's feed because those are the accounts the user interacts with most often. A user having been recommended videos to watch on YouTube is, again, based on that individual's online behavior, digging into what they've watched in the past and what similar users are watching. Elements such as categories, #tags and keywords also factor into recommended content on any given network.

Thus, algorithms in social media platforms can be defined as technical means of sorting posts based on relevancy instead of publish time, in order to prioritize which content a user sees first according to the likelihood that they will actually engage with such content. For example, the posts which are recommended to a given user when that user scrolls through their Instagram feed, or the stories of a user's friends that appear first on the user's dashboard, are determined by algorithms.

Algorithms are designed in a way that takes into account different aspects. Some of these aspects are content-based, meaning that this kind of algorithmic design seeks to match a user's taste, based on their profile, to specific posts that the system guesses the user will like. Once users show interest in a specific tag or category, they are directed to other items in the same category.

Moreover, algorithms can operate in a collaborative way. Collaborative filtering consists in matching users to other users who seem to share similar interests; this way, a person is directed to posts or videos that they might want to see based on the fact that a user with a similar profile searched for that specific source. Algorithms can be context-aware, in the sense that they can individuate personal data such as a user's exact geographic location in order to include it in the algorithmic calculations.

Finally, machine learning uses computers to simulate human learning, which allows them to identify and acquire knowledge from the real world, and improve performance of some tasks, such as recommendations through algorithms, based on this new knowledge.

Different approaches to algorithmic design have consequences when processing cultural content. For example, when engineers set computers through machine learning to create algorithms based on the geographic location of users, they limit—or at least direct—the spread of a particular form of art or of information to that specific area. The effects of algorithmic design can be considered both positive and negative. Often algorithms may be created with the aim of increasing awareness or interest in the digital society on a specific matter, some users may suddenly see in their feed an increase of posts concerning nutrition and diet, or foreign cinema, or politics.

However, the negative implications that algorithmic design may have are often the object of heated discussions on the controversies that surround algorithms. Such controversies often concern privacy issues: algorithms work with the personal data of the social media user, in order to “know” how to display the content on the social media platform (for example, algorithms make use of sensitive data such as the geographical location of the user, the friends and acquaintances they interact the most with, the pages and hashtags that they often search for, et cetera). Similarly, there are also considerations about how algorithms influence the opinion and interests of social media users and, consequently, of the digital society. For greater information on this background see Hunt, R. & McKelvey, F. (2019). Algorithmic regulation in media and cultural policy: a framework to evaluate barriers to accountability. Journal of Information Policy 9, 307-335; Barnhard, B. (2021). Everything that you need to know about social media algorithms. Sproutsocial; and Poepsel, M. (2018). Digital Culture & Social Media, in Media, Society, Culture & You. Rebus Community.

There remains a need for social media AI algorithms to be able to better or more precisely attach a user's sentiment to the concepts formed in the user's posted content.

### SUMMARY OF THE INVENTION

One aspect of the present invention provides a social media platform accessed online by platform user devices forming a collection of interactive media technologies that facilitate the creation and sharing of user created content of information, ideas, interests, and other forms of expression through virtual communities and networks of the user devices wherein the improvement comprises providing a predefined set of sentiment identifiers which are bindable to user defined content component in the user created content; wherein the bound content-sentiment pairings are indexable, searchable and analyzable by the platform or users on the platform.

The social media platform according to claim may provide wherein the predefined set of sentiment identifiers is one of emoticons, emojis and combinations thereof. The social media platform according to the present invention may provide wherein the predefined set of sentiment identifiers includes 2^{N} sentiment identifiers wherein N is an integer. The social media platform according to the present invention may provide wherein users on the platform can search for specific bound content-sentiment pairings, and wherein users search for specific bound content-sentiment pairings will display the searched content-sentiment pairings and related content sentiment pairings.

The social media platform according to one aspect of the present invention may provide wherein an emotional history of select users is maintained by the platform and is formed by the history of all of the content-sentiment pairings that a user has utilized in user created content on the platform. The social media platform according to the present invention may provide wherein an AI algorithm in the social media platform implements the content-sentiment pairings for sorting user created content to prioritize which content is viewed by other users according to the likelihood that they will actually engage with such content, and wherein an AI algorithm in the social media platform implements the content-sentiment pairings for determining a tone associated with the user created content.

One aspect of the present invention provides a social media platform constructed as an interactive Internet-based application hosting User-generated content through online interactions, wherein Users create service-specific profiles for the platform that are maintained by the platform, and wherein the Social media platform facilitates the development of online social networks by connecting a user's profile with those of other individuals or groups, the improvement comprising providing a predefined set of graphical sentiment identifiers which are bindable to user defined content component in the user created content to create a content-sentiment pairing; wherein the bound content-sentiment pairings are indexable, searchable and analyzable by the platform and users on the platform.

One aspect of the present invention provides an AI algorithm in a social media platform for sorting user created content to prioritize which content is viewed by other users according to the likelihood that they will actually engage with such content, wherein the platform provides a predefined set of graphical sentiment identifiers which are bindable to user defined content component in user created content; wherein the bound content-sentiment pairings are indexable, searchable and analyzable by the AI algorithm at least to prioritize which content is viewed by other users according to the likelihood that they will actually engage with such content.

These and other advantages of the present invention will be described below in connection with the attached figures in which like reference numeral represent like elements throughout.

### BRIEF DESCRIPTION OF THE FIGURES

FIG. 1 schematically illustrates a user sending a message on a social media network to another user with the message including a number of discernable concepts and associated sentiments as well as a tone.

FIG. 2 schematically illustrates inherent ambiguity of the binding between concepts and sentiments in prior art social media networks.

FIG. 3 illustrates some examples of possible text bindings or sentiment identifier and alternative visual emoji bindings or sentiment identifiers for associated sentiments in a social media platform according to the present invention.

FIG. 4 schematically illustrates an example of a content-sentiment pairing in a message from one user to another together with a representation of the sentiment pairings of other users for this concept in the social media platform according to the present invention.

FIG. 5 schematically illustrates an example of a feed screen view showing content organized by emotion/concept pairs entered by the user in the social media platform according to the present invention.

FIG. 6 schematically illustrates an example of a find screen view on the users phone which enables a user to find other users and user groups, for “navigating the socio-emotional landscape” in the social media platform according to the present invention.

FIGS. 7A and 7B schematically illustrates an example of a text initiated search screen on the user's phone highlighting a concept and binding a sentiment identifier thereto.

FIGS. 8 and 9 schematically illustrates a screen on the user's phone of search results for the search of FIGS. 7A and 7B.

FIG. 10 schematically illustrates a screen on the user's phone of search results for the search of FIGS. 7A and 7B following the person selecting a match in FIG. 9.

FIGS. 11 and 12 schematically illustrates an example of a sentiment identifier initiated search screen on the user's phone selecting a sentiment identifier and binding a concept thereto.

FIG. 13 schematically illustrates a screen on the user's phone of search results of the search of FIGS. 11-12.

FIG. 14 schematically illustrates a screen on the user's phone of search results for the search of FIGS. 11 and 12 following the person selecting a match in FIG. 12.

FIG. 15 schematically illustrates a screen on the user's phone of a messaging screen for drafting and sending messages to other users.

FIG. 16 schematically illustrates a screen on the user's phone of a mailbox screen for managing messages.

### DESCRIPTION OF THE PRESENT INVENTION

One aspect of the present invention as described in greater detail below provides a social media platform 20, or social media network, accessed online by platform user devices 40 (e.g., smartphones, computers tablets and the like) forming a collection of interactive media technologies that facilitate the creation and sharing of user created content (30) of information, ideas, interests, and other forms of expression through virtual communities and networks of the user devices 40 wherein the improvement comprises providing a predefined set of sentiment identifiers 50 which are bindable to user defined content components 32 of the user created content 30; wherein the bound content-sentiment pairings 52 are indexable, searchable and analyzable by the platform 20 or users 10, 12 on the platform 20. The users 10, 12 of the platform 20 will be referenced collectively as users 10 and 12 unless specifying a sender 10 and a recipient 12 of a message 30. Obviously each user of the platform 20 will switch often between being a sender 10 or recipient 12 of content 30.

The social media platform 20 according to the present invention as described in greater detail below provides wherein the predefined set of sentiment identifiers 50 may be one of emoticons, emojis, textual (i.e. single characters that express emotions about concepts, analogous to “emotional hashtags”) and combinations thereof, and more specifically the sentiment identifiers may be graphical such as one of emoticons, emojis and combinations thereof. The social media platform 20 may provide wherein the predefined set of sentiment identifiers includes 2^{N} sentiment identifiers wherein N is an integer.

The social media platform 20 according to the present invention as described in greater detail below provides wherein users 10, 12 on the platform 20 can search for specific bound content-sentiment pairings 52, wherein users 10, 12 search for specific bound content-sentiment pairings 52 will display the searched content-sentiment pairings 52 and related content sentiment pairings 52.

The social media platform 20 according to the present invention as described in greater detail below provides wherein an emotional history of select users 10, 12 is maintained by the platform 20 and is formed by the history of all of the content-sentiment pairings that a user 10, 12 has utilized in user created content 30 on the platform 20.

The social media platform 20 according to the present invention as described in greater detail below provides wherein an AI algorithm in the social media platform 20 implements the content-sentiment pairings 52 for sorting user created content 30 to prioritize which content 30 is viewed by other users 10, 12 according to the likelihood that they will actually engage with such content 30; and may implement the content-sentiment pairings 52 for determining a tone 36 associated with the user created content 30.

Another aspect of the present invention as detailed further below provides a social media platform 20 constructed as an interactive Internet-based application hosting user-generated content 30 through online interactions, wherein users 10, 12 create service-specific profiles for the platform 20 that are maintained by the platform 20, and wherein the social media platform 20 facilitates the development of online social networks by connecting a user's profile with those of other individuals 10, 12 or groups, the improvement comprising providing a predefined set of graphical sentiment identifiers 50 which are bindable to user defined content component 32 in the user created content to create a content-sentiment pairing 52; wherein the bound content-sentiment pairings 52 are indexable, searchable and analyzable by the platform 20 and users 10, 12 on the platform 20.

Another aspect of the present invention as detailed further below provides an AI algorithm in a social media platform 20 for sorting user created content 30 to prioritize which content 30 is viewed by other users 10, 12 according to the likelihood that they will actually engage with such content 30, wherein the platform 20 provides a predefined set of graphical sentiment identifiers 50 which are bindable to user defined content component 32 in user created content 30; wherein the bound content-sentiment pairings 52 are indexable, searchable and analyzable by the AI algorithm at least to prioritize which content 30 is viewed by other users according to the likelihood that they will actually engage with such content 30.

### Basics

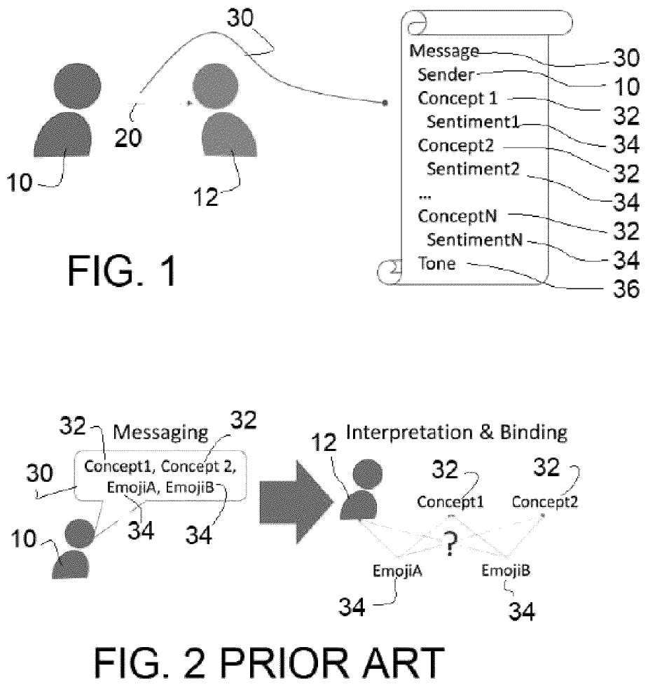

Conceptually, in social media networks, like network 20, users 10, 12 send messages (content 30) to each other. The messages 30 can be sent from one sender 10 to one recipient 12 (see FIG. 1) or from one sender 10 to many recipients 12. The grammar and information of this content 30 is an internet variant of written and spoken language.

The lingua franca of social media, like network 20 of the invention, is a constantly evolving mix of
Abbreviations
Urban slang
Audio clips
Pictures
Gifs
Live and recorded videos
Emojis
Etc.

Modern social media networks enable users to explicitly define concepts, for example as hashtags, e.g., #UserDefinedConcept. The social media platforms are essentially crowdsourcing concept definition, but concepts 32 aren't limited to hashtags and other concepts 32 can be in the message 30, including things, events, locations, time periods, brands, people, etc. A user's sentiment 34 about concepts 32 in general, and hashtags specifically, is scattered throughout the message 30. The messages 30 can be evaluated for both the sender's sentiment 34 about concepts 32, and the sender's tone 36 (e.g. rude or polite). These basics are shown for a simple one user 10 to one user 12 message 30 in Error! Reference source not found., although the basics for a “one to many” message 30 are the same, mainly because sentiment(s) 34 and tone 36 are typically associated with the sender 10, with a potential exception described below, especially for new or silent users 10, 12. The message 30 contains some number of concepts 32, each of which has one or more associated sentiments 34 or “feeling” about the concept 32. The sender 10 may also express a discernible tone 36 within the message 30, which generally ranges from polite to rude.

### Concept Examples

Concepts 32 can be almost anything. One consideration is that users 10, 12 will probably prefer to not have concepts 32 calculated for them based on what others are saying about them to avoid, or at least limit, that as a vehicle for supporting cyber-bullying. Examples of concept 32 categories include:
Ideas
Brands/products/services
Locations/objects
Times/eras
Techniques/actions/activities
Possibly people who consent to have sentiments
Etc.

### Content and Concept Moderation

The role of a concept moderation is important and can be accomplished by a human content moderator, by AI algorithm, by crowd sourcing, and combinations of these. Concepts 32 may have inherent value as predictors of the behavior of social media users 10, 12, which may be referred to herein as “social value,” that is either conducive to positive social interactions or as predictors of negative or destructive social media interactions. Simple examples are “altruism,” as a potential predictor of positive interactions, and “being abusive” as a potential negative predictor. Concepts 32 could be neutral with respect to the potential to predict positive or negative social media interactions. A simple neutral example is “biking” as a concept 32. As the social media platform 20 desires to foster positive social interactions, the social value of a concept 32 can be important. This may require human interaction of the content moderator to manually define or via input of users 10 12 via a crowd sourced definition. AI could also be used as a concept's social value could be defined by the spectrum, and frequency, of sentiments 34 users 10 and 12 express about the concept 32. In a straightforward introductory example, numerical values associated with concepts 32 can be defined as either +1 (welcoming), 0 (neutral) or −1 (excluding). Similarly, at least for the purposes of this simple example, sentiments 34 can be +1 (positive), 0 (neutral) or −1 (negative). If it is assumed tone 36 is independent of sentiment 34, and that sentiment 34 is more important than tone 36, the example can start with values for tones 36 that are +½ (polite), 0 (cordial) or −½ (rude).

Sentiment 34 can interact with social value in a straightforward way. For the example of a user 10 sending the message 30 “I hate it when someone is being abusive”, negative sentiment 34 of “I hate . . . ” (−1) for the associated excluding concept 32 “being abusive” (−1) multiplies −1 X −1 to give a result of +1, and an expectation of positive social interactions for this user 10. Similarly, for the message 30 “I love altruism”, positive sentiment 34 of “I love . . . ” (+1) for the associated welcoming concept 32 “altruism” (−1) would also provide an expectation of positive social interactions for this user 10 who says they love altruism. For someone 10 who says in a message 30 “I love being abusive”, positive sentiment 34 for “I love . . . ” (+1) for an excluding concept 32 “being abusive” (−1) multiplies +1 X −1 for −1 and an expectation of negative social interactions for this user 10. A statement 30 of “I hate altruism” would similarly multiply a negative sentiment 34 and a positive welcoming concept 32 for a negative social value.

The neutral states for concepts 32, sentiment 34 and tone 36 can be either calculated and used in some fashion or they can be ignored. Another variant of the simple system described above uses scalar scores instead of trinary or binary values for concepts 32, sentiment 34 and tone 36.

It is possible to also consider the tones 36 of senders 10 who are “friends” of a user 12, and/or the tones 36 of senders 10 to whom someone 12 has “subscribed” as an additional variable for management of the system 20.

The roles of a concept 32 and content moderator (or AI or crowd sourcing addressing this aspect) can therefore include the following: Definition of concepts 32 as inherently welcoming/excluding/neutral; and Relative weight of sentiment 34/concept 32 (e.g., +1 or −1) vs tone 36 (e.g., +½ or −½)

### Problem of Sentiment Identification and Sentiment/Concept Binding Clarity

Sentiments 34 and their bindings to associated concepts 32 can be challenging to determine. Sometimes AI can help identify sentiments 34 in messages 34 and assign them to concepts 32. It is not uncommon, however, for the interpretation of such bindings within a given message 30 to be significantly ambiguous. Sometimes the verbal description of emotion is not clear so it is difficult to accurately identify sentiment 34. One common example in existing platforms is someone 10 who sends a message 30 identifying concepts 32 and then includes emojis (sentiments 34). There is a clear intent to communicate emotional content, so the sentiment identification is at least straightforward. But is the user communicating how they feel in general or how they feel about the concepts in their message. If there are multiple concepts, and multiple emojis, how do they map? This problem is shown graphically in Error! Reference source not found. schematically illustrating the ambiguity of the binding between concepts 32 and sentiments 34 in prior art networks. Even in the example of clearly defined concepts 32 and clearly defined sentiments 34 in the form of emojis, the bindings or pairing in the message 30 can be ambiguous.

### Crowdsourcing Combined Concepts, Sentiments and Sentiment/Concept Bindings

The platform 20 enables and encourages users 10, 12 to message in ways that explicitly define concepts 32, sentiments 34 and bindings (forming pairs 52) between sentiments 34 and concepts 32 provides a valuable solution to these problems. The platform 20 of the present invention crowdsources sentiment 34 and concept 32 definitions and sentiment/concept bindings 52. It accomplishes these goals by using sentiments 34 (via sentiment identifiers 50) AS concept 32 labels. One simple example expresses positive, neutral or negative feelings about a concept 32 using “+” to denote “positive”, “˜” to denote “uncertain or neutral” and “−” as “negative”:
+concept (positive), ˜concept (uncertain or neutral) and −concept (negative)

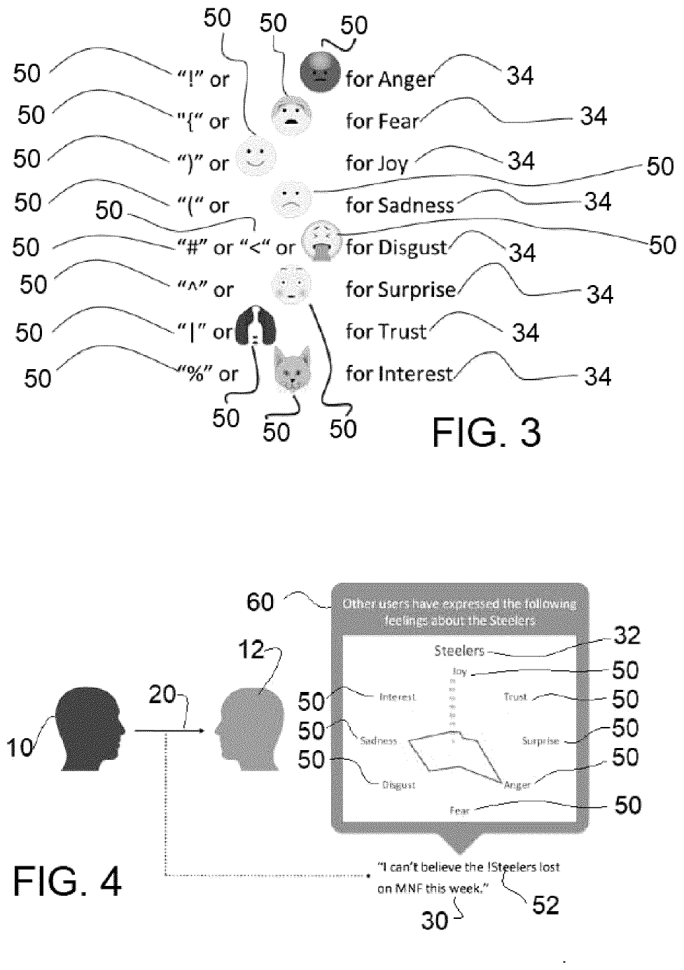

One concern with this limited example, of course, is that using “+/˜/−” as the range of sentiment identifiers 50 is one dimensional, from an emotional perspective. To express a richer range of emotions, it is possible to define additional sentiment identifiers 50 or character bindings for major emotions. The same emotions could be expressed visually using emojis for sentiment identifiers 50. An important distinction in the platform 20 of the invention and existing networks is that the emoji, as a sentiment identifier 50, would be linked or “bound” to a single word or phrase (concept 32) in a sentiment/concept binding 52, with the user 10 thereby signifying “I am feeling this emotion (Sentiment 34 represented by sentiment identifier 50) about this concept (32)” instead of just including an emoji in a text stream without a specific binding as in the existing networks. Examples of text bindings or sentiment identifier 50 and alternative visual emoji bindings or sentiment identifier 50 for sentiments 34 is shown in FIG. 3.

Further given that not every concept 32 and sentiment 34 will be identified by users 10, 12, a useful supplement to crowdsourcing concepts 32, sentiments 34 and sentiment/concept bindings 52 is an artificial intelligence/machine learning (“AI/ML”) approach for sentiment/concept/binding and tone 36 analysis for “common internet messaging language.” The results from AI/ML can be used in parallel with, or as a supplement to, use of crowdsourced sentiment/concept bindings 52. It may be desirable to implement initial versions of the extended emotion framework of the system 20 using the character or text bindings as sentiment identifiers 50, with migration to the option of using emojis for sentiment identifiers 50 in a later version of the system 20. It may be desirable to prohibit the expression of select emotions/sentiments toward users 12 to limit options for cyber bullying within the platform 20.

### Tone

Tone 36 can be extracted simply by the AI/ML component, and searching for profanity may be implemented for detecting tone 36.

User Value of Explicit Emotions about Concepts

The straightforward sentiment expressions offered by sentiment identifiers 50 in the network 20 of the invention can add significant value to online social interactions. They can provide real time status on users' feelings for a particular concept 32. An example showing how users can understand the social impact of their football team's loss on Monday Night Football appears in FIG. 4. FIG. 1 is a schematic representation of user value derived from clear concept/sentiment bindings 52. A user 10 conveys a his concept-sentiment pairing 52 to another user 12 on a concept 32 in a message 30 over the platform 20 and the users gets real time feedback from the system 20 summarizing the current feelings relating to their football team's recent loss on Monday Night Football. The radar/spider diagram 60 is one potential display approach for visually displaying the concept/sentiment bindings 52 of other users (10, 12) for the concept 32 (the Steelers football team). Others visual display possibilities could include a bar chart with each bar corresponding to the strength of one of the concept/sentiment bindings 52 expressing user community's combined feelings.

### Modes of Implementing Concept-Sentiment Pairing

A user 10 on the platform 20 implementing the present invention can utilize the concept-sentiment pairing 52 in postings, in determining who to follow or who can follow them as well as group messaging, and individual messaging. The concept-sentiment pairing 52 allows users on the platform 20 to search for people based on a feeling or sentiment 34 and a concept 32, possibly with other associated feeling/concept combos (52) and/or with other words/concepts 32 without associated feelings or sentiments 34.

### Scaling

As noted above the platform 24 implements a pre-determined set of sentiment identifiers 50 (emoticons or emojis or textual), or more preferably, graphical sentiment identifiers 50 (emoticons or emojis), preferably in a 2^{N} number in which N is an integer (such as 3). Eight graphical sentiment identifiers 50 is recommended as it allows for a reasonable number and range of distinct sentiments 34 to be expressed while still allowing an easy to follow graphical display of all of the sentiments 34 for a given concept 32 (such as in radar/spider diagram 60). Given the platform's representation of distinct sentiment identifiers 50 in its binary coding, keeping the pre-set number at a 2^{N} number improves scaling. The platform scales up the approach most easily in groups of 2ⁿ sentiment identifiers 50 (8 to 16 to 32 to 64, etc.), but as noted above eight seems like a good compromise of assorted considerations (high intersectionality, easy visualization and searching, etc.).

### Unique Emotional History

As noted above the platform 20 preferably tracks an emotional history of each user 10 which is all of the emotion/concept combinations (concept-sentiment pairings 52) that a user 10 has ever used. This emotional history can be utilized by the AI algorithm of the platform for matching the individual 10 with like-minded individuals 12 or groups, or with other users 12 and groups that this user 10 is most likely to have meaningfully engagement. The emotional history can be considered an emotional fingerprint of the user 10.

### Searching Concept-Sentiment Combinations

As noted above the platform 20 according to the present invention provides a predefined set of sentiment identifiers 50 which are bindable to user defined content component 32 in the user created content 30; wherein the bound content-sentiment pairings 52 are indexable, searchable and analyzable by the platform 20 and the users 10, 12 on the platform 20. Indexing the content-sentiment pairings is listing and sorting of the concept-sentiment pairings 52.

Searching the concept-sentiment pairings 52 is a navigation of a social/emotional landscape. Searching the concept-sentiment pairings 52 will yield destinations which are people 10, 12 who have a similar emotional fingerprint AND a tendency to be welcoming vs exclusionary based on their willingness to interact with people 10, 12 with different emotional fingerprints. Topic or content 32 searching of the content-sentiment pairings 52 highlights people 10, 12 who have provided the same emotion 34 about the same topic 32 and people 10, 12 who have provided different emotions 34 about the same topic 32 while providing a consensus of emotions 34 about that topic 32. Clicking on one emotional axis of a radar plot 60 triggers display of people 10, 12 who have that emotion 34 about that topic 32. Clicking on a place on the radar plot 60 between axis triggers display of people 10, 12 who have that combination of emotions 34 about that topic 32, if any (i.e. the two adjacent emotions 34)

### Platform Auto-Behaviors

One aspect of the platform 20 of the invention may provide that auto emotion highlighting, similar to auto-spell program, creates a space or balloon or visible indicator around each word or topic or concept 32 recognized by the platform 20 and the indicated space suggests to users a “nearby” (in spelling and emotional space) word/concept that has emotions 34 associated with it on the platform 20. The platform 20 has the capacity to associate more than one feeling 20 with a concept 32. Alternatively the platform 20 can indicate when a word (concept 32) has emotions 34 behind it during auto-fill/spell check using italics or color or blinking

The platform 20 allows connection through emotions and can have an emotional pattern or fingerprint for each person 10. The platform 20 can connect with people 10, 12 who are intentionally similar or intentionally different and may use empathy as a driver of connection. It is contemplated the platform 20 has a survey for new users 10, 12 to fill out when they sign up for a new account which shows how the new user 10, 12 feels about an assortment of concepts 32 to begin forming an emotional pattern for the user 10, 12. As noted the platform 20 can connect with people 10, 12 through specific feelings 34 about specific concepts 32.

As one representative example, someone 10 pregnant who is considering whether to have the baby could send a message or create content 30 with the concept-sentiment pairing 52 “afraid->pregnancy” and reach out to people 12 who are/were also scared of pregnancy. The platform 20 would suggest connections with people 12 who are currently experiencing that emotion 34 for empathy, and further the platform 32 may suggest connections with people 12 who experienced that emotion 34 at various times in the past for lessons learned and suggestions for how to proceed.

Feelings or sentiments 34 could be communicated by a color or other visual saliency cues signifying the dominant feeling either to the platform 20 or sent from the platform 20 or signifying the mix of feelings using a blend of color:
Red for Anger
Yellow for Fear
Green for Joy
Blue for Sadness
Orange for Disgust
Purple for Surprise
Underline for Trust
Blinking for Interest

### Coding for Efficient Large-Scale Communication of Others' Feelings

Concept coding via concept-sentiment pairings 52 on the platform 20 are preferably held locally and updated intermittently, either nearly persistent with daily/weekly/monthly/yearly update or “urgent” right now for a new concept 32 that is generating a lot of traffic. A Concept ID library may, for example reference concepts 32 in 64 bits. Feeling IDs are implicit by the bitwise order of (for example 8) feeling scores. As an example, Feeling score for each ID 1-100 in 8 bits. Feeling summary for 8 feelings with 8 bit scores for each in a total of 64 bits. Then in summary 64 bit concept ID library, 64 bits for each ID and words of some reasonable (128 bits for 16 letters) bit length for each ID=64 concepts×64 feeling bits per concept+64 concepts×128 bit word per concept=4,096+8,192=12,288 bits or 1,536 bytes or ˜1.5 KB. As suggested above this can scale up in groups of 2 sentiment identifiers 50 (8 to 16 to 32 to 64).

### I/O and Time-Limitation of Feedback

The platform 20 allows users 10 to trigger the sending of feelings or sentiments 34, and immediate receiving of feedback summarizing the feelings or sentiments 34 sent by others 12, by sending or searching with a feeling(s)/concept bindings 52. With this configuration the user 10 is not sending feelings 34 randomly and wasting bandwidth. The receipt of other user's feeling summaries can be time-limited or limited by the duration of time it takes for a person 10 to send a message (i.e. the summaries of others' feelings 34 on a concept 32 are displayed until the person 10 sends their message) or it could be continually updated in a person's feed.

### Privacy

User 10, 12 privacy is critical particularly when binding sensitive sentiments 34 to concepts 32. The platform 20 can allow users 10, 12 to emote and search to get aggregate info, but someone 10 can't reach out to individuals 12 or get individual identities of people 12 who have emoted privately about some concept 32. Only people 12 who have emoted in broadcast or publicly in groups show up in specific emotion searches, but private emotions 34 can influence emotional fingerprint matches and suggested contacts based on the fingerprint match component of matching.

The platform 20 allows for a private mode user 10, 12 joining groups where group membership is not public, but id info (name, profile picture) of users 10, 12 is shared within group. For example, consider the platform 20 allows users 10, 12 to join and participate in an alcoholic support group where nobody could see the user “going into/out-of” the meetings. Private groups have only private participants, and Public groups have only public participants. Hybrid public/private groups allow either private or public participants. Broadcast emotions and emotions in public groups are not private. Emotions expressed in private groups are private outside the group (could consider behavior for overlapping groups) and included in de-identified aggregate data. Direct message is private and included in de-identified aggregate data

### Search Control/Troll Screening

One aspect of the platform 20 of the invention is that the search extent can be limited to only first second or third order contacts. If a user 10 specifies via the software interface, it is possible to have the platform 20 search for emotional expressions among the user's direct contacts (through following, group membership or direct messaging), aka “first order contacts”, or among first order contacts and the direct contacts of first order contacts, aka “second order contacts” or among second order contacts and the direct contacts of second order contacts, aka “third order contacts.”

Another aspect of search/screening control in the present invention is screening message inputs/response messages to tune them to the desired level of positivity or negatively. In this manner trolls can be “screened out” if desired. In other words, the emotion/concept pair 52 framework is useful as a way to screen feedback to mitigate users' negative emotional impacts from trolls.

One way for a user to specify the desired level of positivity or negativity is using a “response sentiment slider”. When the user 10, 12 slides the setting to one side, they receive only positive messages and they receive only negative messages after sliding the slider setting to the other side. When the user 10, 12 slides the slider to settings in the middle, the platform 20 sends a corresponding ratio of positive to negative responses. The platform 20 randomly selects messages that are screened in/out and limits excessive messages based on the number of deficient messages. An example is the user picking a 5 positive to 1 negative message ratio and there are 100 negative messages and 10 positive messages. In this example, the platform would display the 10 positive messages and would randomly select 2 of the 100 negative messages to display. Positive emotions/emojis sentiment identifiers 50 include curiosity, joy, and trust, and optionally including surprise. Negative emotions/emojis sentiment identifiers 50 include anger, fear, and disgust, optionally including sadness

With the platform 20 of the present invention it is possible to use crowd-sourcing to circumvent one vulnerability of this approach. The vulnerability is for a troll to use a positive emotion concept pair 52 and to append a negative emotional message. An example, is the equivalent of providing an emoji (or character) 50 paired with the message 30 that conveys “your post gives me joy” but then adding a text component to the message 30 afterwards that says “but I really hate your post”, although real world examples could be much more subtle (or not). Users 12 who receive these messages 30 can flag these messages 30, with subsequent review by AI and/or human moderators. If the review upholds the flag, there can be multiple outcomes: the user's message can be blocked and they can be given a specific “troll rating” to warn users of their history of negative platform behavior.

Another aspect of the platform 20 of the present invention is it is possible to use the spider diagram 60 as an input device (as compared with its illustrated use as an output device) as a more detailed way to specify the ratio of desired types of message inputs or response messages. A user 12 can draw the ratio of feelings expressed as inputs/response messages as a pattern on a spider diagram 60. The system 20 then screens response messages 30 to correspond to this ratio, using the rarest, most desired message types as incremental gates for the other message types. As an example, a user could draw a pattern that corresponded to a disgust=1, anger=2, sadness=3, fear=4, surprise=5, trust=6, curiosity=7 and joy=8. The system 20, in the example of having 100 disgust messages, 90 anger messages, 80 sadness messages, 70 fear messages, 60 surprise messages, 50 trust messages, 40 curiosity messages and 30 joy messages, could randomly select and communicate 3 disgust messages, 6 anger messages, 9 sadness messages, 12 fear messages, 15 surprise messages, 18 trust messages, 21 curiosity messages and 24 joy messages.

### Representative Example

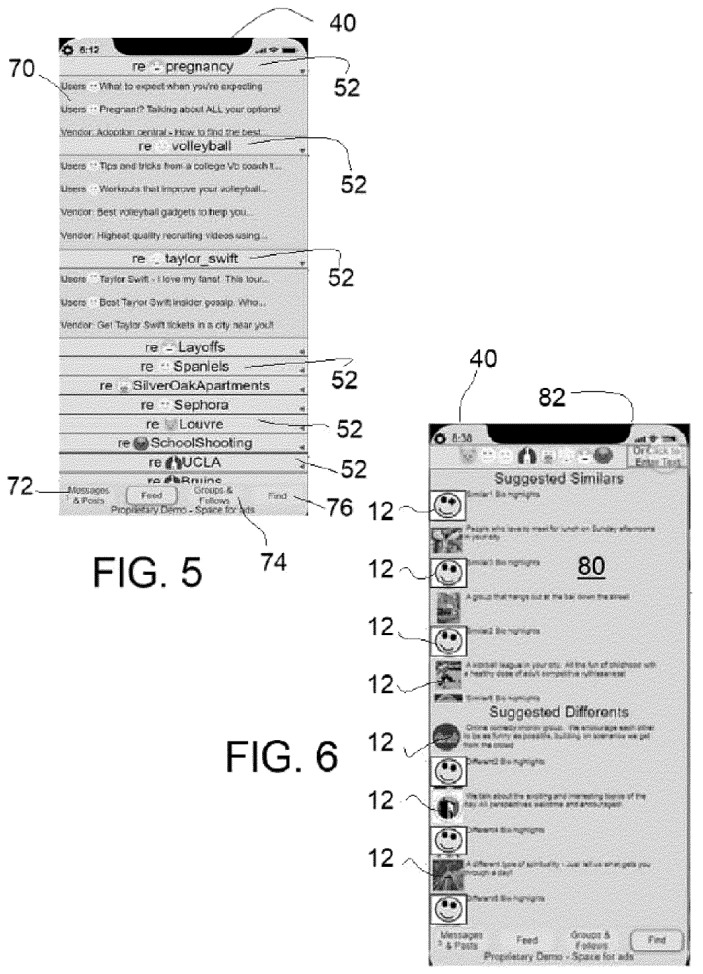

The context of the scenario illustrated in the screenshots is that someone 10 who lives in another part of the USA has a new job in Pittsburgh and is trying to decide where to live in the Pittsburgh region. FIG. 5 schematically illustrates an example of a Feed screen view 70 on the user's phone 40 showing content organized by emotion/concept pairs 52 entered by the user 10 in the social media platform 20 according to the present invention. This view is a “bottomless” stream of info including platform-recommended person and group content (for example based on popularity even if not strictly speaking the best match), ads (“Vendor: . . . ”) and matching based on a combination of emotional fingerprint and that same emotion(s)/concept pair. Other screen views 70 are listed as selectable tabs at the bottom (“Messages & Posts” 72, “Groups & Follows” 74, “Find” 76). There is space for “always on” user-targeted ads. Cursor highlights the area that, when clicked, will advance the app to the next screen view. The feed screen view 70 (also called main screen or initial screen) may be set or may be the same as the last screen the user 10, 12 had displayed (feed vs messages/posts vs groups/follows vs “find people”).

FIG. 6 schematically illustrates an example of a find screen view 80 on the user's phone 40 which enables a user 10 to find other users 12 and user groups (also 12), for “navigating the socio-emotional landscape.” This action initiates one of two alternative ways to perform a search in search bar 82. One search style starts with entering text in the box in bar 82. The other, shown later, starts with entering an emotion (shown here using emojis as sentiment identifiers 50). In addition to the option to initiate a search, the platform suggests people 12 who have a similar emotional fingerprint and others 12 who have similar topics 32 they emote about but different emotions 34 expressed. These people 12 care about the same things, but have different feelings about those things compared to the current user 10.

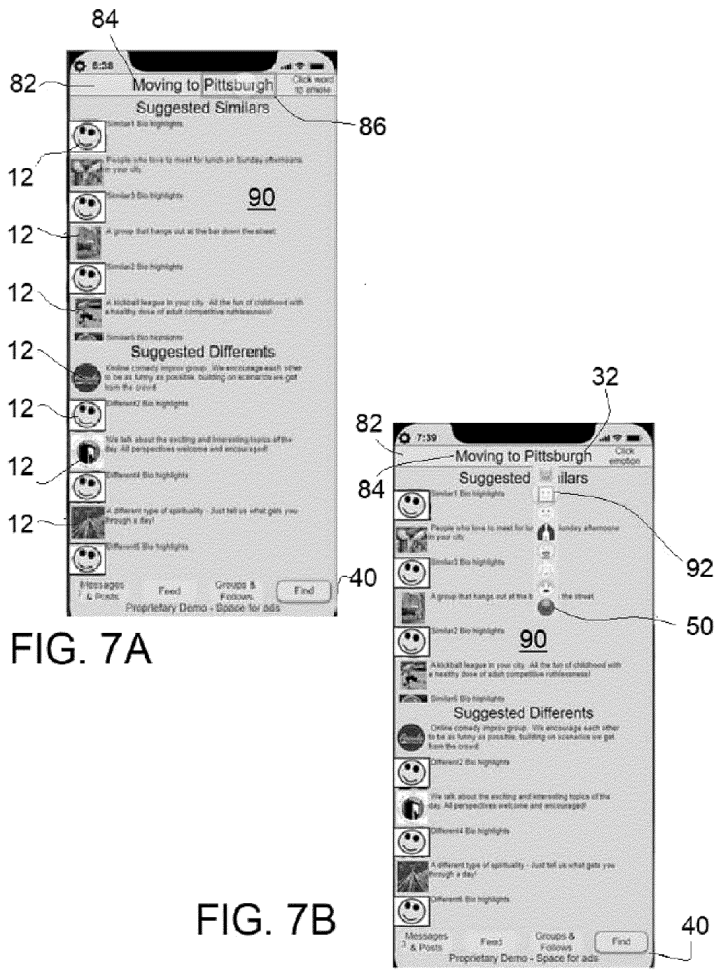

FIG. 7A schematically illustrates an example of a find text initiated search screen 90 on the user's phone 40 highlighting with a box 86 a concept 32 in a search string 84 to add or bind a sentiment identifier 52 thereto. This search started with entering text 84 “Moving to Pittsburgh” in the box in bar 82 from screen 80. At least one word/concept 32 needs of the string 84 to be selected as the search on string 84 here is powered by emotions or sentiments 34 in the sentiment concept pairings 52. Highlighting the concept 32 provides a pull down screen of sentiment identifiers 50 as shown in FIG. 7B and the desired one is selected at 92 to be paired with the concept 32, and the search can commence.

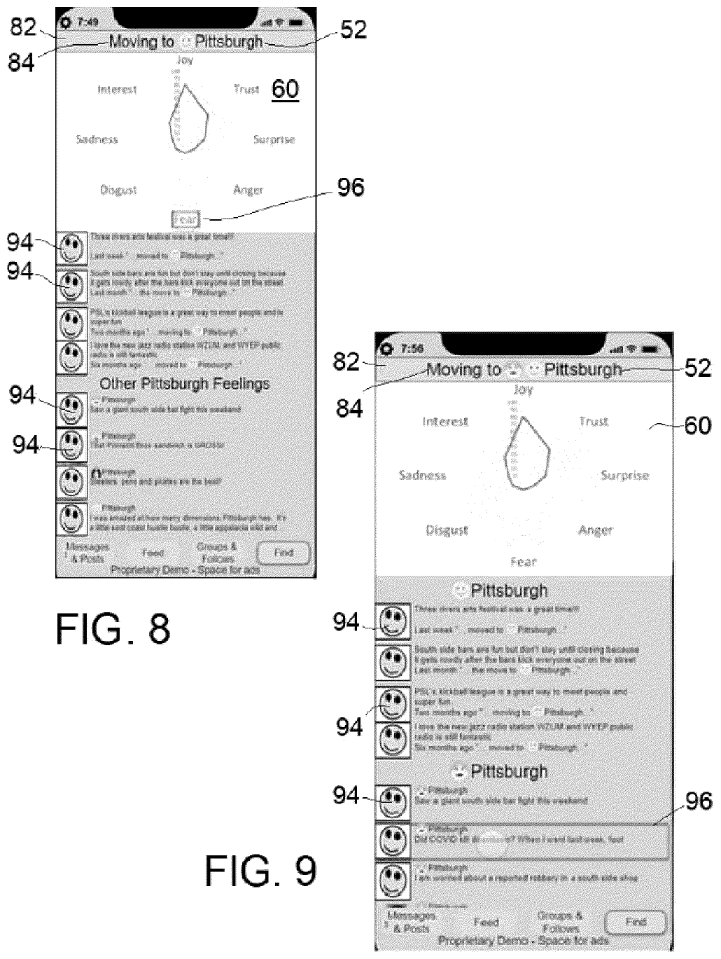

FIG. 8 is a screen of search results for the search of FIGS. 7A and 7B. The search displays a spider diagram 60 of all of the accumulated emotions 34 on the platform 20 about the concept 32 paired with the emotion 34 in the pair 52. The top matches 94 are prioritized for example by referencing the emotion/concept pair 52 and versions of the non-emotion paired word(s) (moving, moved, move, etc. in this example) and possibly also by the level of match of the user's/group's emotional fingerprint with the person or group with the user 10 who initiated the search. The bottom matches 94 are other expressions of emotion 34 about the concept 32 paired with the emotion in the pair 52 and are prioritized, for example, by emotional fingerprint match and by version of the non-emotion paired word(s). The axes of the spider diagram 60 are clickable and, when clicked, guide the bottom “other feelings” portion of the search results. In the example shown, the user 10 is specifically interested in people who are fearful of Pittsburgh and is selecting at 96 this axis to determine for example if there are any worries and any suggestions about how to address them.

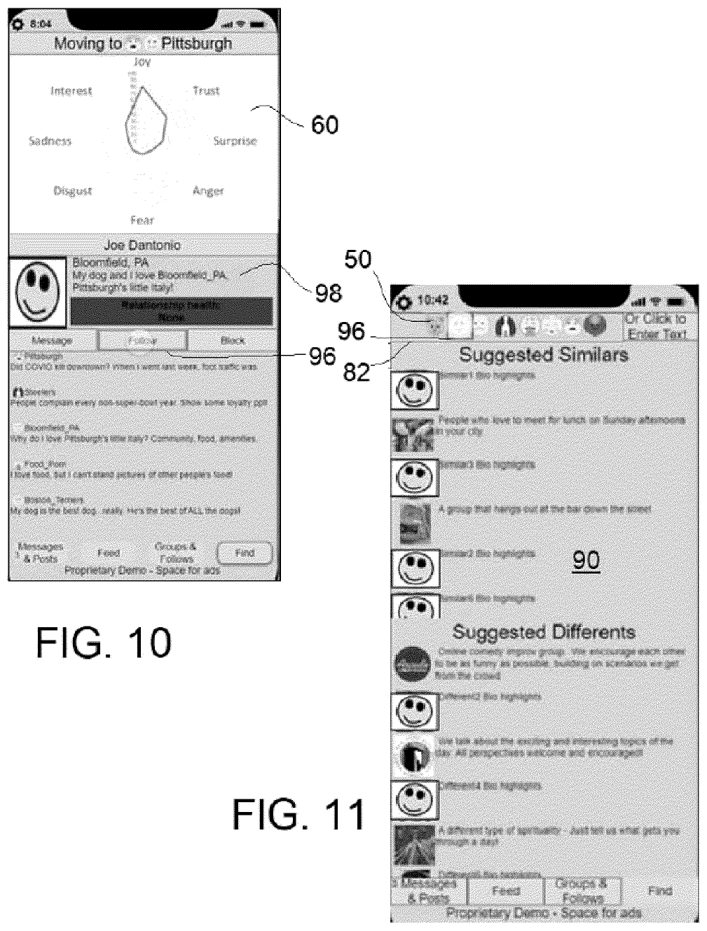

FIG. 9 is also a screen of search results for the search of FIGS. 7A and 7B discussed above in connection with FIG. 8. Here one of the matches 94 or people identified is of interest because they expressed a concern about the death of downtown, an area that might be a place to live. The user 10 selects or clicks 96 on the person's profile overview to get more details. FIG. 10 is also a screen of search results for the search of FIGS. 7A and 7B following the person selecting the match 94 in FIG. 9. The details 98 of the person of the selected match details are displayed as shown in FIG. 10, showing they have some interesting and useful perspectives, and the user 10 decides to follow them with selection or click 96 in the follow.

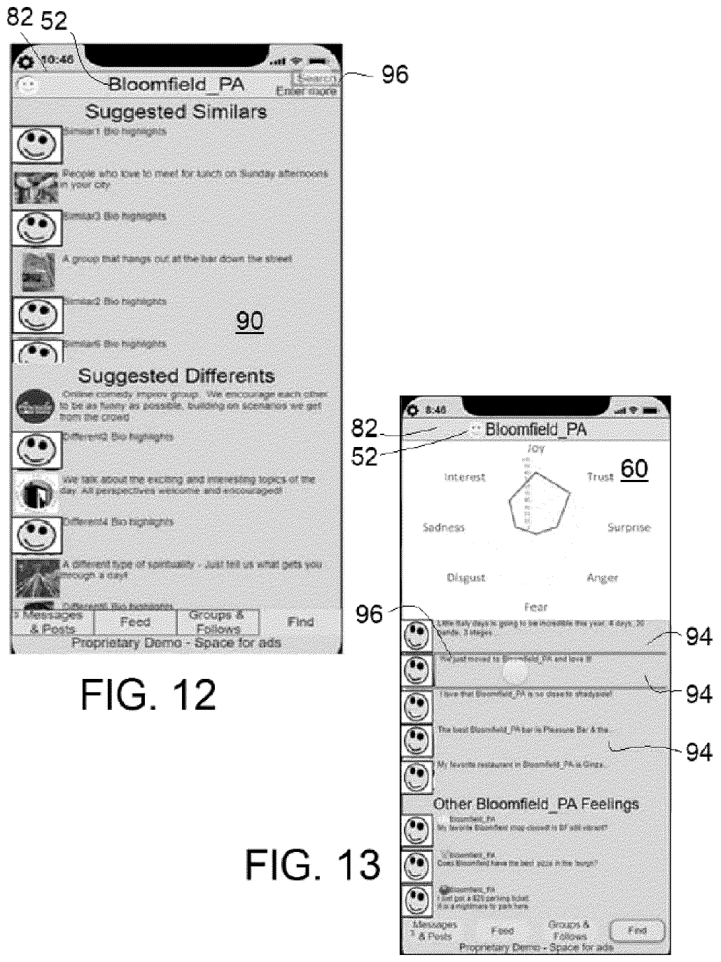

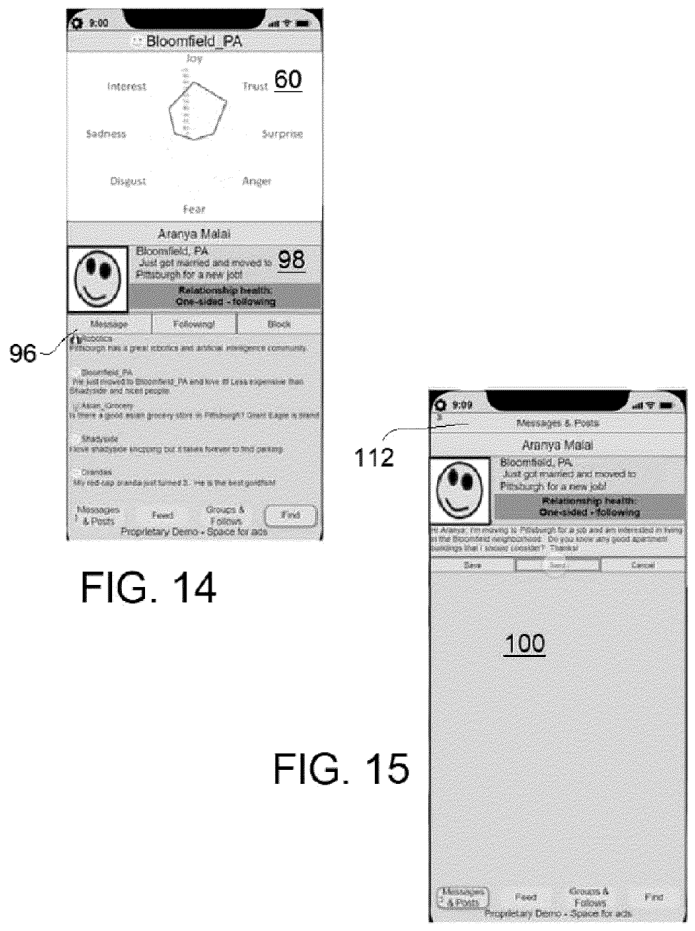

In this example the user 10 desires to do another search based on the followed user's (from the selected match 94) enthusiastic reference to the lovely Pittsburgh neighborhood of Bloomfield, PA. The user 10 decides to use the other search style, with initial selection 96 of an emotion 34 represented by sentiment identifier 50, then typing a concept 34, specifically by selecting 96 a joy emotion or sentiment identifier 50 in the form of an emoji. As shown in FIG. 11 the user 10 returns to the search screen 90 and selects or clicks 96 a desired sentiment identifier 50 to begin this search. FIG. 12 shows adding the concept (Bloomfield PA) 34 in the search bar 82 to create a concept-sentiment pairing 52 and then selecting 96 search. FIG. 13 schematically illustrates a screen on the user's phone 40 of search results of the search of FIGS. 11-12. The search displays a spider diagram 60 of all of the accumulated emotions 34 on the platform 20 about the concept 32 paired with the emotion 34 in the pair 52. The top matches 94 are prioritized as noted above with the user shown selecting 96 a match 94. Specifically the person of the selected match 94 indicated said she just moved to Bloomfield. The user 10 clicks 96 on this match 94 (her summary) to get more background. The details of the match are shown in FIG. 14 (similar to FIG. 10) and the user 10 can select to follow this match 94, as well as message the person of this match as shown with click or selection 96.

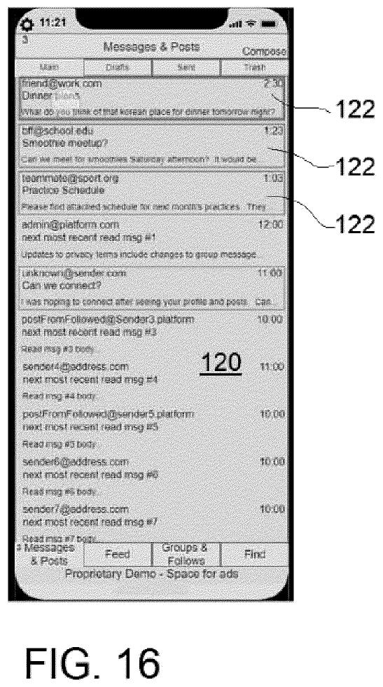

FIG. 15 schematically illustrates a messaging screen 100 where the user 10 can draft and send a message with click 96, with FIG. 15 showing a message being sent. The controls allow for saving, sending or cancelling a message by the user 10. The messaging screen 100 is also notifying the user 10 that they have three new messages or posts in banner 112 wherein the user 10 elects to open the mailbox screen 120 shown in FIG. 16 by clicking banner 112 to view messages 122. The top message 122 in this example shown in FIG. 16 asks a question about tomorrow, so it's desirable to read the message 122 and possibly reply. User 10 can click on the message 122 to read it and to reply forward or delete the message as desired. A reply or forwarding of the message returns the user to the messaging screen for composing a desired reply (or forwarded message).

Following this example the messages and reply may prompt the user to conduct another search, such as for the location of the Shadyside mentioned several times in the earlier search. The system 20 also gives the user 10 the ability to follow individual and groups and the group and follow icon will direct the user to a screen for managing these components. As evidenced by this example the social media platform 20 is accessed online by platform users 10, 12 via their devices 40 thereby forming a collection of interactive media technologies that facilitate the creation and sharing of user created content of information, ideas, interests, and other forms of expression through virtual communities and networks of the user devices 40, which is generally common to other networks. The improvement comprises providing a predefined set of sentiment identifiers 50 which are bindable to user defined content component 34 in the user created content 30; wherein the bound content-sentiment pairings 52 are indexable, searchable and analyzable by the platform 20 or users 10, 12 on the platform 20.

Although the present invention has been described with particularity herein, the scope of the present invention is not limited to the specific embodiments disclosed. It will be apparent to those of ordinary skill in the art that various modifications may be made to the present invention without departing from the spirit and scope thereof.

What is claimed is:

1. A social media platform accessed online by platform user devices forming a collection of interactive media technologies that facilitate the creation and sharing of user created content of information, ideas, interests, and other forms of expression through virtual communities and networks of the user devices wherein the improvement comprises providing a predefined set of sentiment identifiers which are bindable to user defined content component in the user created content; wherein the bound content-sentiment pairings are indexable, searchable and analyzable by the platform or users on the platform.

2. The social media platform according to claim 1 wherein the predefined set of sentiment identifiers is one of emoticons, emojis and combinations thereof.

3. The social media platform according to claim 1 wherein the predefined set of sentiment identifiers includes emojis.

4. The social media platform according to claim 1 wherein the predefined set of sentiment identifiers includes 2^{N} sentiment identifiers wherein N is an integer.

5. The social media platform according to claim 1 wherein users on the platform can search for specific bound content-sentiment pairings.

6. The social media platform according to claim 5 wherein users search for specific bound content-sentiment pairings will display the searched content-sentiment pairings and related content sentiment pairings.

7. The social media platform according to claim 1 wherein an emotional history of select users is maintained by the platform and is formed by the history of all of the content-sentiment pairings that a user has utilized in user created content on the platform.

8. The social media platform according to claim 1 wherein an AI algorithm in the social media platform implements the content-sentiment pairings for sorting user created content to prioritize which content is viewed by other users according to the likelihood that they will actually engage with such content.

9. The social media platform according to claim 1 wherein an AI algorithm in the social media platform implements the content-sentiment pairings for sorting user created content to prioritize which content is viewed by other users according to the likelihood that they will actually engage with such content.

10. The social media platform according to claim 1 wherein an AI algorithm in the social media platform implements the content-sentiment pairings for determining a tone associated with the user created content.

11. A social media platform constructed as an interactive Internet-based application hosting user-generated content through online interactions, wherein users create service-specific profiles for the platform that are maintained by the platform, and wherein the social media platform facilitates the development of online social networks by connecting a user's profile with those of other individuals or groups, the improvement comprising providing a predefined set of graphical sentiment identifiers which are bindable to user defined content component in the user created content to create a content-sentiment pairing; wherein the bound content-sentiment pairings are indexable, searchable and analyzable by the platform and users on the platform.

12. The social media platform according to claim 11 wherein an emotional history of select users is maintained by the platform and is formed by the history of all of the content-sentiment pairings that a user has utilized in user created content on the platform.

13. The social media platform according to claim 11 wherein an AI algorithm in the social media platform implements the content-sentiment pairings for at least one of i) sorting user created content to prioritize which content is viewed by other users according to the likelihood that they will actually engage with such content; and ii) determining a tone associated with the user created content.

14. The social media platform according to claim 11 wherein users on the platform can search for specific bound content-sentiment pairings.

15. The social media platform according to claim 14 wherein users search for specific bound content-sentiment pairings will display the searched content-sentiment pairings and related content sentiment pairings.

16. An AI algorithm in a social media platform for sorting user created content to prioritize which content is viewed by other users according to the likelihood that they will actually engage with such content, wherein the platform provides a predefined set of graphical sentiment identifiers which are bindable to user defined content component in user created content; wherein the bound content-sentiment pairings are indexable, searchable and analyzable by the AI algorithm at least to prioritize which content is viewed by other users according to the likelihood that they will actually engage with such content.

17. The AI algorithm in a social media platform according to claim 16 wherein the AI algorithm in the social media platform implements the content-sentiment pairings for sorting user created content to prioritize which content is viewed by other users.

18. The AI algorithm in a social media platform according to claim 16 wherein the AI algorithm in the social media platform implements the content-sentiment pairings for determining a tone associated with the user created content.

19. The AI algorithm in a social media platform according to claim 16 wherein the AI algorithm in the social media platform implements an emotional history of select users which is formed by the history of all of the content-sentiment pairings that a user has utilized in user created content on the platform.
